(19) United States
(12) Patent Application Publication
(10) Pub. No.: US 2026/0065770 A1
(43) Pub. Date: Mar. 5, 2026

(54) MULTI-UTILITY WEARABLE OBSTACLE DETECTION AND ALERTING DEVICE

(71) Applicants: Aarya Patnaik, Pleasanton, CA (US); Sweta Patnaik, Pleasanton, CA (US)

(72) Inventors: Aarya Patnaik, Pleasanton, CA (US); Sweta Patnaik, Pleasanton, CA (US)

(21) Appl. No.: 18/823,734

(22) Filed: Sep. 4, 2024

(51) Int. Cl. G08B 25/01; G01S 15/08; G08B 3/10; G08B 21/02

(52) U.S. Cl. CPC G08B 25/016; G01S 15/08; G08B 3/10; G08B 21/02

(57) ABSTRACT

The present invention comprises a novel wearable device capable of detecting an obstacle's distance directly ahead of the device using ultrasonic sound waves and alerting the wearer/user once the object crosses a distance threshold. The distance threshold at which alerting begins may be configured, and the alerting is in the form of sound beeps. The alerting sound beeps get faster as the aforementioned object comes closer to the wearer/user to provide updates on the change of distance, which may lead to avoidable collision. In preferred embodiments, the present invention is optionally wearable on clothes using a clip or a standard belt using the aforementioned clip or as the belt buckle. The present invention also comprises a rechargeable battery with multiple ports that can be used to recharge compatible portable devices such as mobile phones.

### REFERENCE TO RELATED APPLICATIONS

This application claims the benefit of U.S. Provisional Ser. No. 63/582,852 , filed Sep. 15, 2023, which is incorporated by reference herein in its entirety.

### BACKGROUND OF THE INVENTION

Noise-less traffic has increased dramatically recently with the growth of electric vehicles and electricity-powered transportation. This poses great difficulty for people with visual impairment.

Such people may use walking sticks to detect obstacles ahead of them. However, the walking stick has a minimal range of obstacle detection, which is limited to the length of the stick. The user of the walking stick does not detect any obstacle beyond the length of the walking stick.

Obstacle detection is not limited to people with visual impairments. Many workers in warehouses move pallets using manual pallet jacks. To do so, they need to walk backward to retrieve the pallet before they can move it. While walking backward, it is necessary to have obstacle detection and alerting to prevent colliding with the obstacles.

A further need for obstacle detection exists for people who are engrossed in their mobile devices while walking and need to be alerted about obstacles ahead to avoid potential injury.

The present invention can be used in any scenario where obstacle detection and alerting for human beings is required. Even if a person is stationary and not moving, an object such as an electric vehicle may come close and must be avoided. For example, a car approaching a person standing on the edge of a curb. Alerting for such objects is necessary to prevent human injury.

### SUMMARY OF THE INVENTION

The present invention comprises a novel wearable device capable of sensing an object's distance directly ahead of the device using ultrasonic sound waves and alerting the wearer/user once the object crosses a distance threshold. The distance threshold at which alerting begins may be configured, and the alerting is in the form of sound beeps. The alerting sound beeps get faster as the aforementioned object comes closer to the wearer/user to provide updates on the change of distance, which may lead to avoidable collision. In preferred embodiments, the present invention is optionally wearable on clothes using a clip or a standard belt using the aforementioned clip or as the belt buckle. The present invention also comprises a rechargeable battery with multiple ports that can be used to recharge compatible portable devices such as mobile phones.

### BRIEF DESCRIPTION OF DRAWINGS

Some embodiments of the present invention are illustrated as an example and are not limited by the figures of the accompanying drawings, in which like references may indicate similar elements and in which:

FIG. 1 depicts an exploded two-dimensional perspective view of one example of a wearable obstacle detection and alerting device according to various embodiments of the present invention.

FIG. 2 illustrates an exploded three-dimensional left-hand side bottom-up perspective view of one example of a wearable obstacle detection and alerting device according to various embodiments of the present invention.

FIG. 3 illustrates an exploded three-dimensional right-hand side top-down perspective view of one example of a wearable obstacle detection and alerting device according to various embodiments of the present invention.

FIG. 4 depicts an example of a front profile view of a wearable obstacle detection and alerting device according to various embodiments described herein.

FIG. 5 depicts an example of a left-hand side profile view of a wearable obstacle detection and alerting device according to various embodiments described herein.

FIG. 6 depicts an example of a back profile view of a wearable obstacle detection and alerting device according to various embodiments described herein.

FIG. 7 depicts an example of a right-hand side profile view of a wearable obstacle detection and alerting device according to various embodiments described herein.

FIG. 8 illustrates an example of a front profile view of a prototyped preferred embodiment of a wearable obstacle detection and alerting device according to various embodiments described herein.

FIG. 9 illustrates an example of a left-hand side profile view of a prototyped preferred embodiment of a wearable obstacle detection and alerting device according to various embodiments described herein.

FIG. 10 illustrates an example of a right-hand side profile view of a prototyped preferred embodiment of a wearable obstacle detection and alerting device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New wearable obstacle detection, alerting, and battery recharging devices, apparatuses, and methods for obstacle detection and alerting are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered an exemplification of the invention and is not intended to limit the invention to the specific embodiments illustrated by the figures or description below.

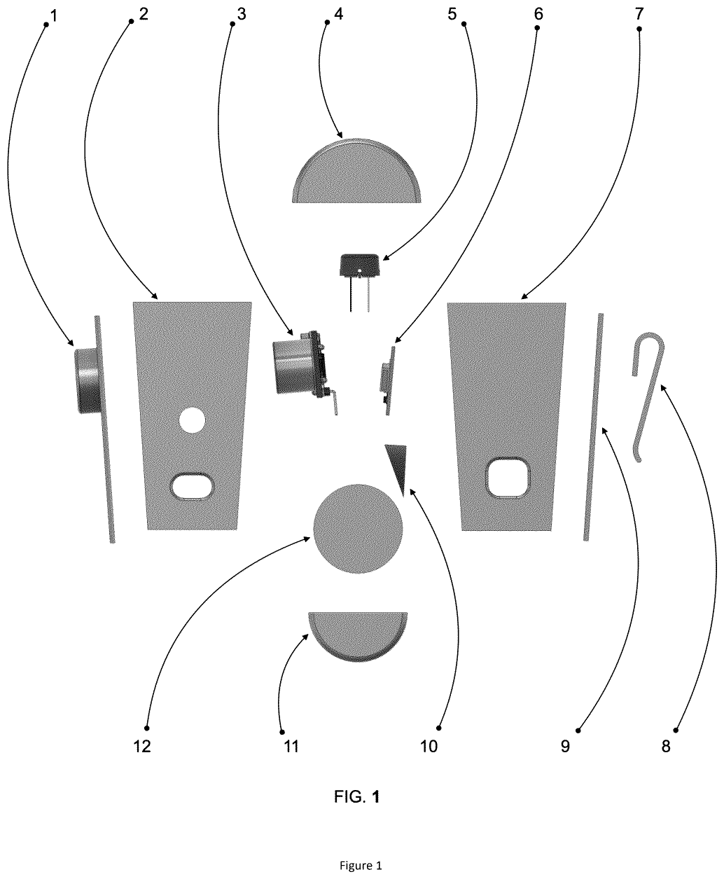

The present invention will now be described by referencing the appended drawings/figures representing preferred embodiments. FIG. 1 depicts an exploded perspective view of the elements that may comprise a wearable obstacle detection, alerting, and battery recharging device (hereinafter called “THE DEVICE”) according to various embodiments of the present invention. In preferred embodiments, each of the components of THE DEVICE is securely held in place by clasp/s or fastened and/or joined to at least one or more other component/s of THE DEVICE so that all components in union make THE DEVICE a solid object that can be held, worn and/or operated by humans. The front cover 1 is joined with the right side cover 2, the left side cover 7, the top cover 4, and the bottom cover 11. The back cover 9 is fastened to the other covers 1, 2, 7, 4, and 11 using clasp types, screw types, and/or any suitable threaded fastener.

In preferred embodiments of THE DEVICE, the clothes/belt clip 8 is fastened to the back cover 9 using clasp types and/or any suitable threaded fastener for ease of removability by the wearer. This allows THE DEVICE to be worn on clothes or a standard belt at any position: front, side, or back. The rechargeable battery 12 is securely held in place with clasps, and the power viewer window 10 is joined with the back cover 9 to provide the wearer with a digital or analog reading of the remaining charge.

The ultrasonic distance sensor module 3 provides non-contact distance measurement functionality. In preferred embodiments of THE DEVICE, the functionality of the distance sensor module 3 is achieved by using HC-SR04 sensors or similar electronic components. The microcontroller board with flexible digital interfaces 6 reads the distance measured by distance sensor module 3 and triggers the buzzer 5 based on a comparison of distance measured with a configurable threshold. In preferred embodiments of THE DEVICE, the functionality of the microcontroller board 6 is achieved by using Raspberry Pi Pico or similar electronic components, and the functionality of the buzzer 5 is achieved by using a Piezo Buzzer or alternative alerting components such as a vibration or light component.

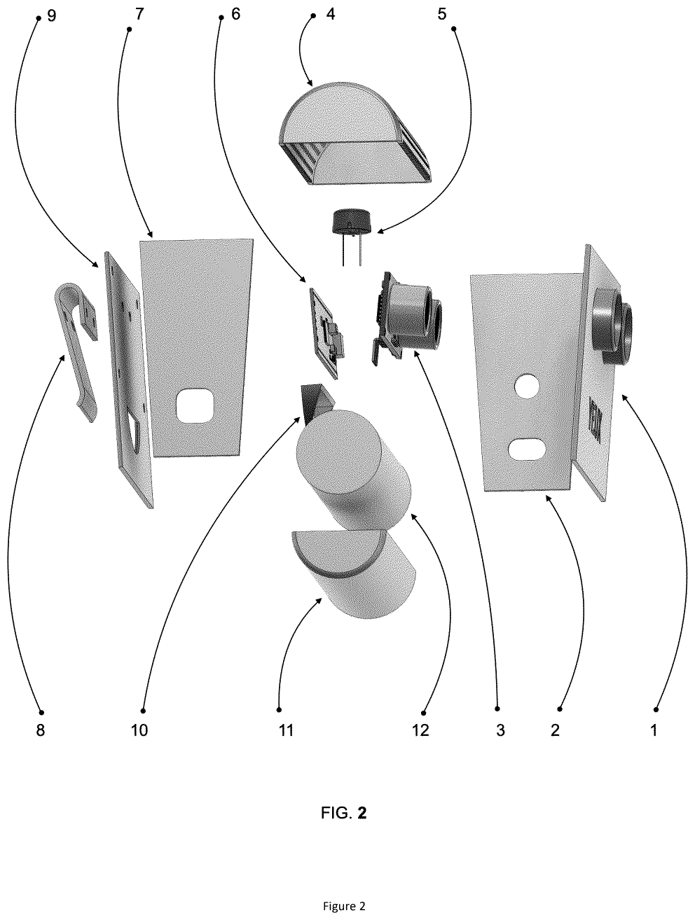

Referring now to FIG. 2, the components of THE DEVICE are shown in an exploded three-dimensional left-hand side bottom-up perspective view according to various embodiments of the present invention. Most notably, FIG. 2 shows the apertures and slots in front cover 1, right side cover 2, left side cover 7, back cover 9, and clothes/belt clip 8. There are fastener apertures in the clothes/belt clip 8 and back cover 9 that accept screw type or any suitable threaded fasteners. The two extruded slots in front cover 1 allow exposure of the transmitter and receiver parts of distance sensor module 3. Such exposure unhindered by the front cover 1 is required for accurate distance measurement.

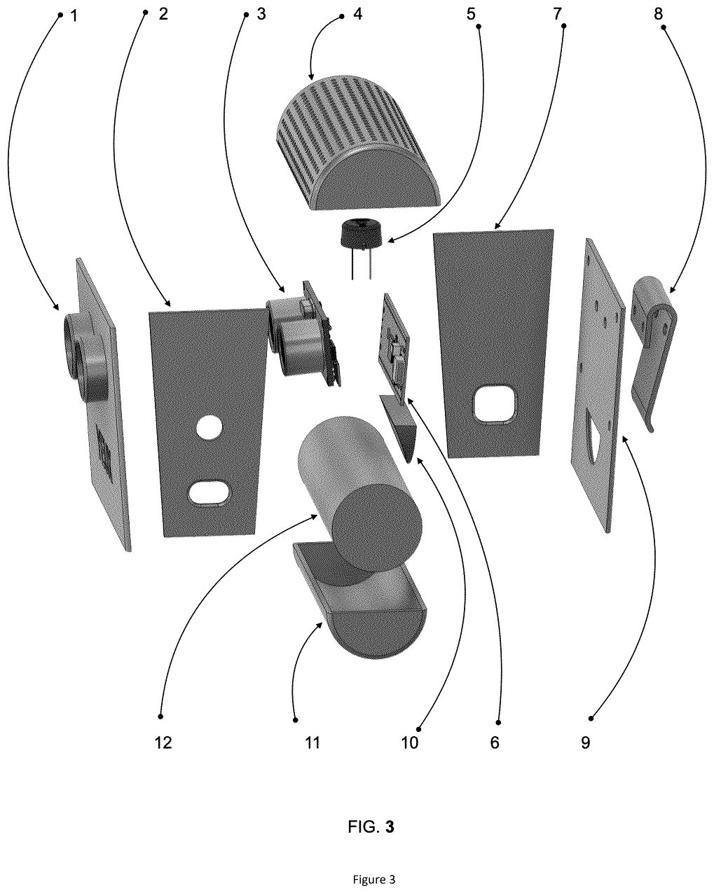

Referring now to FIG. 3, the components of THE DEVICE are shown in an exploded three-dimensional right-hand side top-down perspective view according to various embodiments of the present invention. Most notably, FIG. 3 shows the perforated structure of top cover 4 to allow sound beeps produced by the buzzer 5 to be heard by the wearer of THE DEVICE.

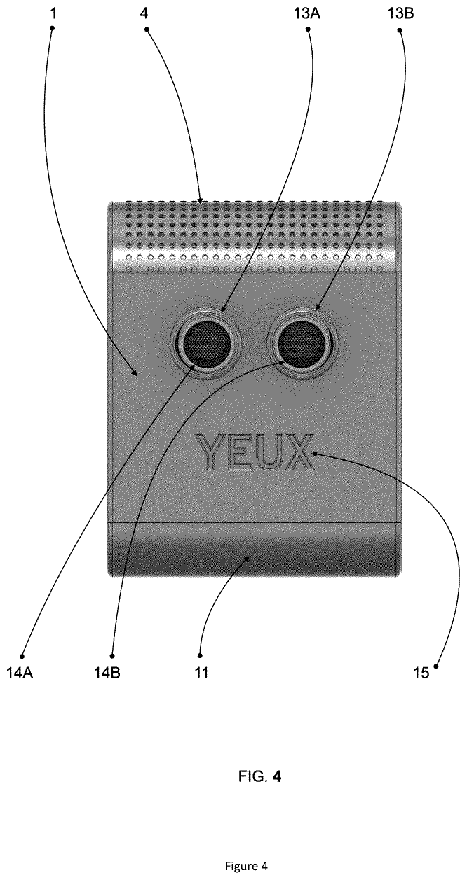

As perhaps best shown in FIG. 4, all components of THE DEVICE are assembled, depicting an example of a front profile view of THE DEVICE according to various embodiments described herein. The extruded slots 13A and 13B in the front cover 1 allow protected exposure of the transmitter and receiver parts 14A and 14B of distance sensor module 3. The name-branding/logo placeholder 15 is for marketing purposes and is illustrated with name-branding set to YEUX (meaning Eyes, in French) as an example.

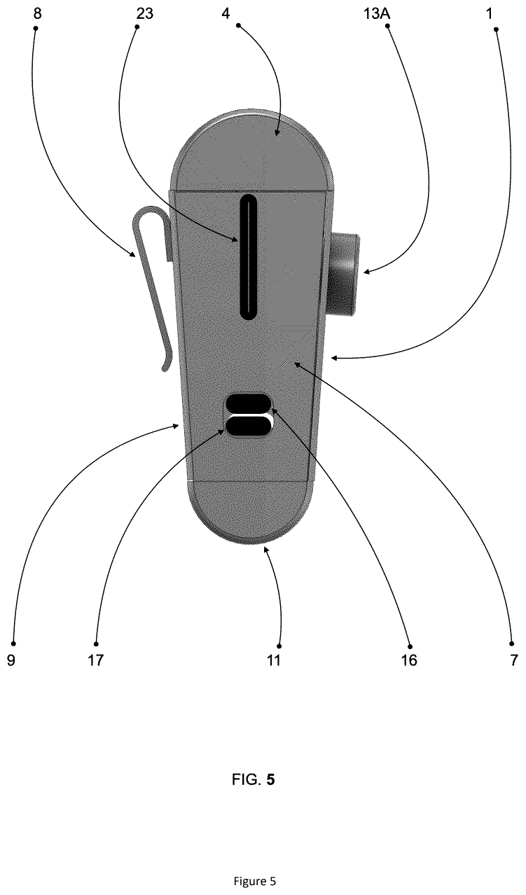

FIG. 5 depicts an example of a left-hand side profile view of THE DEVICE according to various embodiments described herein. When pressed, the rechargeable battery press-button switch 16 displays the remaining battery charge in the power viewer window through the back cover 9. The lightning connector port 17 allows connecting a lightning cable to recharge compatible portable devices such as mobile phones. The optional left belt clasp 23 can be used when wearing THE DEVICE as a belt buckle, in which case the clothes/belt clip 8 may be removed.

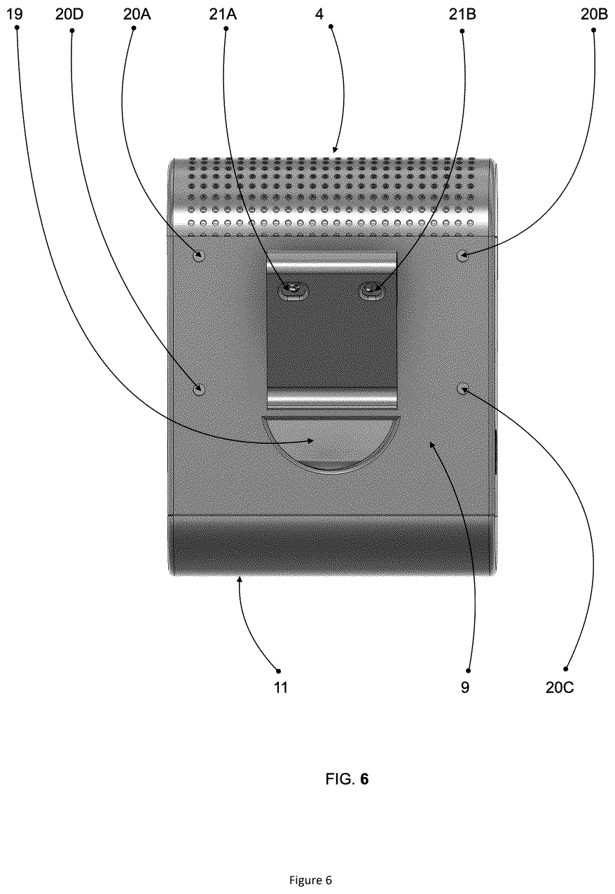

FIG. 6 depicts an example of a back profile view of THE DEVICE according to various embodiments described herein. The power viewer window 19 is open through the back cover 9, allowing the wearer/user to view the remaining battery charge by pressing the battery press-button switch. The fastener apertures 20A, 20B, 20C, and 20D in the back cover 9 and fastener apertures 21A and 21B in clothes/belt clip 8 accept screw type or any suitable threaded fasteners.

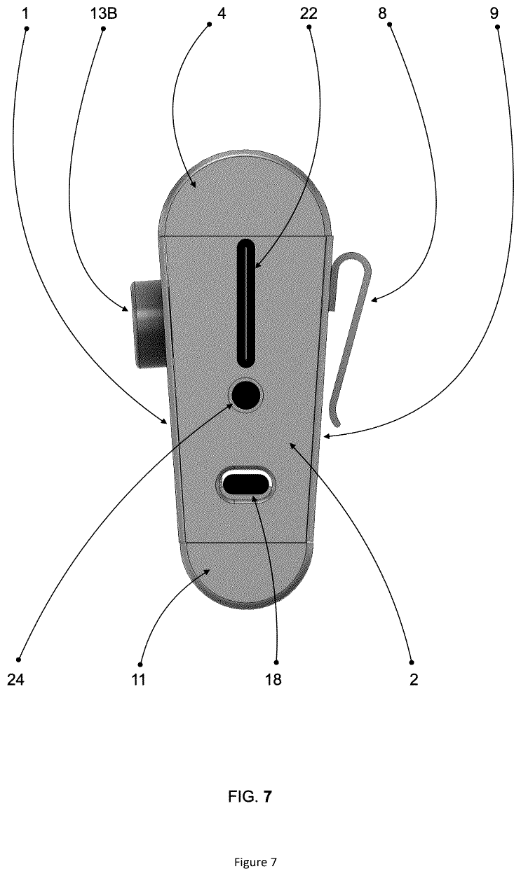

FIG. 7 depicts an example of a right-hand side profile view of THE DEVICE according to various embodiments described herein. The USB-C connector port 18 allows connecting a USB-C cable to recharge compatible portable devices such as mobile phones. The optional left belt clasp 22 can be used when wearing THE DEVICE as a belt buckle, in which case the clothes/belt clip 8 may be removed. The power button 24 is a press button switch used by the wearer/user to turn THE DEVICE on/off.

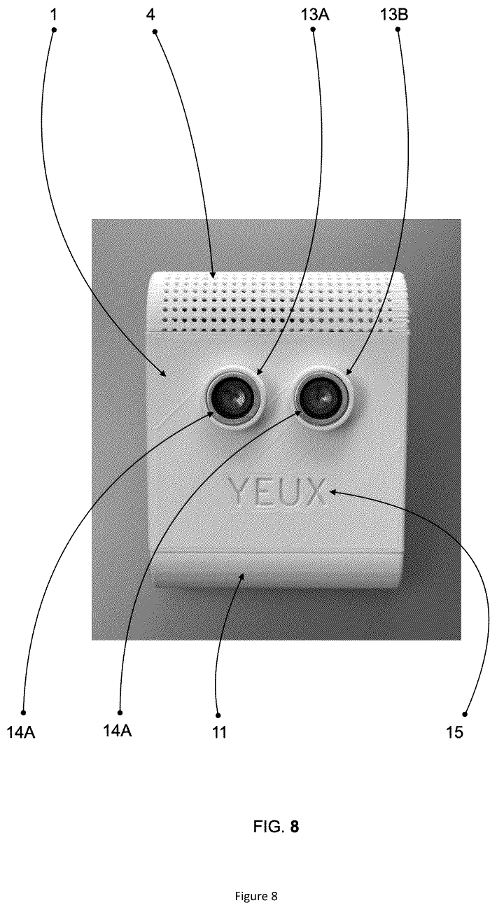

FIG. 8 illustrates an example of a front profile view of a prototyped preferred embodiment of THE DEVICE according to the present invention. The extruded slots 13A and 13B in the front cover 1 allow protected exposure of the transmitter and receiver parts 14A and 14B of distance sensor module 3. The name-branding/logo placeholder 15 example is also clearly illustrated.

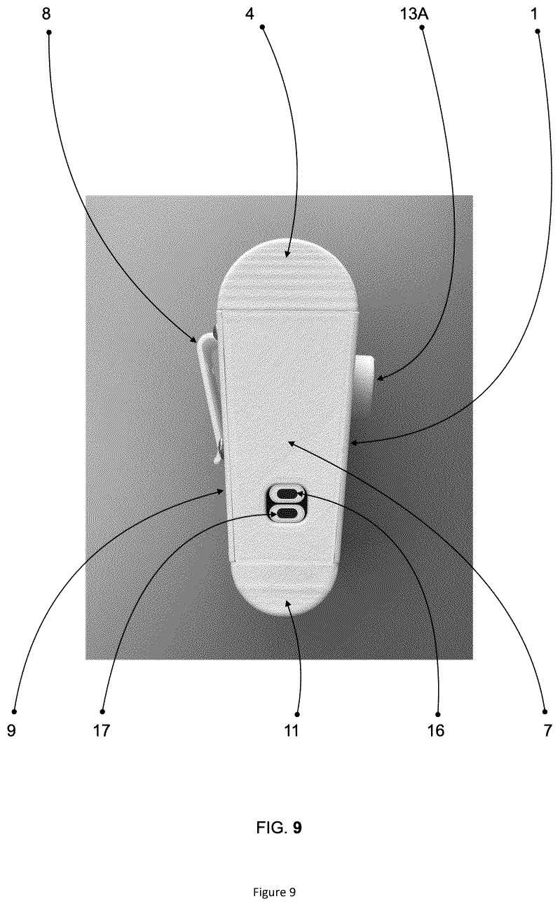

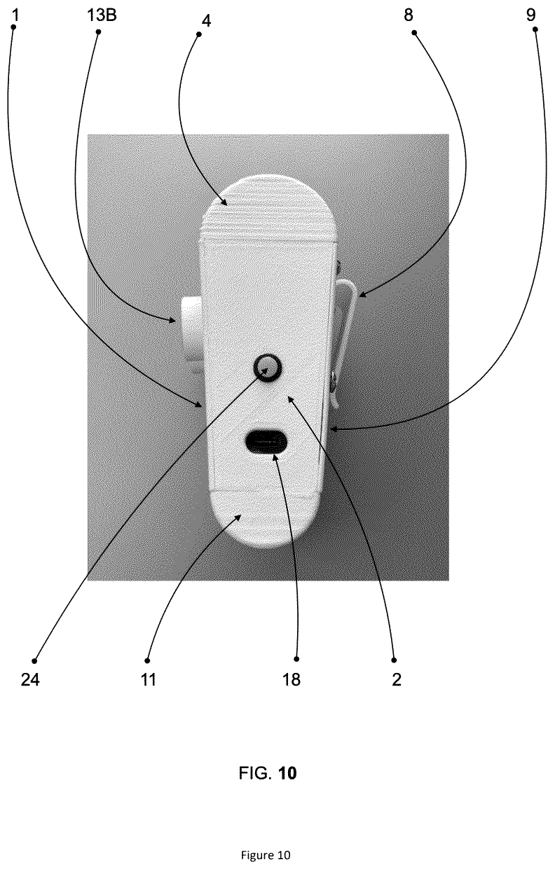

FIG. 9 illustrates an example of a left-hand side profile view of a prototyped preferred embodiment of THE DEVICE according to the present invention. The rechargeable battery press-button switch 16, and lightning connector port 17 are clearly illustrated. FIG. 10 illustrates an example of a right-hand side profile view of a prototyped preferred embodiment of THE DEVICE according to the present invention. The power button 24 and USB-C connector port 18 are clearly illustrated.

While preferred electronic components have been illustrated and described herein, THE DEVICE is not limited by these components. Although the present invention has been illustrated and described herein with reference to preferred embodiments and specific examples thereof, it will be readily apparent to those of ordinary skill in the art that other embodiments and examples may perform similar functions and/or achieve similar results. All such equivalent embodiments and examples are within the spirit and scope of the present invention, are contemplated thereby, and are intended to be covered by the following claims.

What is claimed is:

1. A human-wearable obstacle detection and alerting device; THE DEVICE comprising:
a. A non-contact distance sensor;
b. A microcontroller board;
c. A buzzer or alternative alerting component;
d. A rechargeable battery that powers THE DEVICE and functions as a rechargeable battery source for other compatible devices;
e. Cover units that securely contain the aforementioned components as a single unit;
f. Clothes/belt clips and clasps that allow the device to be worn by a user.

2. THE DEVICE is capable of detecting obstacles in the direction of movement and alerting the wearer with sound beeps or other alerting mechanisms for detected obstacles.
